(19) United States
(12) Patent Application Publication
(10) Pub. No.: US 2019/0296315 A1
(43) Pub. Date: Sep. 26, 2019

(54) CONNECTION DEVICE FOR ELECTRICALLY CONNECTING ELECTRIC STORAGE UNITS

(71) Applicant: Robert Bosch GmbH, Stuttgart (DE)

(72) Inventors: Eduard Reimer, Fellbach (DE); Matthias Oechsle, Ditzingen-Hirschlanden (DE)

(21) Appl. No.: 16/464,086

(22) PCT Filed: Oct. 5, 2017
(86) PCT No.: PCT/EP2017/075353

§ 371 Date: May 24, 2019

(30) Foreign Application Priority Data
Nov. 25, 2016 (DE) 10 2016 223 464.1

(51) Int. Cl. H01M 2/20; H01R 11/09

(52) U.S. Cl. CPC H01M 2/206; H01R 2201/26; H01M 2220/20; H01R 11/09

(57) ABSTRACT

The invention relates to a connection device (10) for electrically connecting electric storage units (110), in particular of a motor vehicle, the connection device comprising at least two insulation layers (11) and comprising connection elements (12) arranged between the insulation layers (11), wherein the connection elements (12) are outwardly electrically insulated by the insulation layers (11), and each connection element (12) has, on a first end, at least one cell connector (14) provided for connecting the electric storage units (110), and/or a terminal connection (15), wherein the cell connector and/or the terminal connection is/are integrally bonded with the connection elements (12).

### BACKGROUND OF THE INVENTION

The present invention relates to a connecting device for electrically connecting electrical storage units, in particular of a vehicle, to a battery module, and to a method for producing a connecting device for electrically connecting electrical storage units.

DE 10 2012 218 500 A1 has disclosed a device for connecting multiple electrical energy stores. Here, the contact elements are fixed in a common carrier, wherein the electrically conductive contact elements are encapsulated or insert-molded in the carrier material in cumbersome fashion.

### SUMMARY OF THE INVENTION

According to a first aspect of the invention, a connecting device for electrically connecting electrical storage units, in particular of a vehicle, is provided. The connecting device has at least two insulation layers and connecting elements arranged between the insulation layers, wherein the connecting elements are electrically insulated to the outside by means of the insulation layers, and the connecting elements each have, at a first end, at least one cell connector, which is provided for the electrical connection of the electrical storage unit, and/or a terminal connection. The cell connector and/or the terminal connection are in this case formed cohesively with the connecting elements.

Further features and details of the invention will emerge from the subclaims, from the description and from the drawings. Here, features and details that have been described in conjunction with the connecting device according to the invention self-evidently also apply in conjunction with the battery module according to the invention and the method according to the invention and vice versa in each case, such that reciprocal reference is always or can always be made in respect of the disclosure relating to the individual aspects of the invention.

According to the first aspect of the invention, by means of the connecting device, an at least electrical contact system for electrical connecting is provided, wherein the electrical storage units are provided in particular for an at least electrically driveable vehicle. The electrical storage units may in this case preferably be in the form of battery cells, in particular prismatic battery cells. The connecting device is of sandwich-like form and has at least three layers. A first layer is formed by a first (electrical) insulation layer, wherein connecting elements, cell connectors and/or at least one terminal connection are arranged, at least in part, on the first insulation layer. The second (electrical) insulation layer is arranged on the intermediate layer formed by the connecting elements, the cell connectors and/or the at least one terminal connection, such that the connecting elements, the cell connectors and/or the at least one terminal connection are electrically insulated to the outside at least in certain portions. It is preferable here if the connecting elements are completely surrounded by the insulation layers. By contrast, the cell connectors and/or the at least one terminal connection may be surrounded by the insulation layers only in certain portions. The insulation layers make it possible firstly for the connecting elements, in particular the cell connectors and/or the at least one terminal connection, to be electrically insulated to the outside, and preferably at the same time for mechanical stability to be provided by the insulation layers, such that the connecting device is of flexible form and can nevertheless be partially dimensionally stable. The connecting elements may be in the form of conductor tracks, in particular in wire and/or grid form. The insulation layers make it possible to realize connecting elements which are electrically insulated to the outside, and which are at the same time protected against external environmental influences, in particular corrosion. Here, the insulation layers may be of chemically resistant form, preferably formed from a polymer or plastic, at least in certain portions. This refers in particular to resistance to chemical constituents of a battery cell that may for example be released in the event of outgassing of the battery cell.

The connecting elements may advantageously each have, at a second end, a connection contact, such that an electrically conductive connection to an electronics unit can be produced. The electronics unit may in this case be in the form of a PCB (printed circuit board) or circuit board, in particular for a battery management system (BMS) or a cell supervising circuit (CSC). The corresponding hardware (BMS, CSC, PCB) may be electrically connected to the connection contacts of the connecting elements, such that information items of the electrical storage units, in particular of the battery cells, can be transmitted via the connection contacts. The information items may for example be states of charge, temperature of the battery cells or the like. It is furthermore conceivable for the connection contacts to be in the form of (RFID) antennae, such that a substantially contactless transmission of information items of the battery cell can be established. The connection contacts are preferably arranged in the middle/centrally in the connecting device, in particular such that the electronics unit is connectable, in particular solderable, in electrically conductive fashion to the connection contacts.

It is conceivable for the cell connectors and/or the terminal connection to be arranged at an edge side on the insulation layer and to be surrounded at least in certain portions by at least one (or more) insulation layer(s). In the context of the invention, “at an edge side” is to be understood to mean at a periphery on the insulation layer. Accordingly, the cell connectors and/or the at least one terminal connection may be arranged at a longitudinal side and/or at a width side of at least one insulation layer. Here, in particular, the cell connectors are arranged parallel to one another and spaced apart from one another at an edge side on the insulation layers. This permits a simple connection of the cell connectors to the corresponding electrical storage units, in particular the battery cells, and a connection of the at least one terminal connection to a further battery module or to an external consumer. The terminal connection may be in the form of a high-voltage contact, in particular as a multipoint connector.

It is particularly preferable if at least one insulation layer is of foil-like, in particular flexible, form and has at least plastic or aluminum oxide. Here, “foil-like” may be understood in particular to mean extruded foil, blown foil or cast foil. Here, the insulation layer is of foil-like form before it is connected in contact with the connecting elements, the cell connectors and/or the at least one terminal connection or a further insulation layer. Accordingly, the insulation layer is not cast around the connecting elements, the cell connectors or the terminal connection. In this way, the construction of the connecting device is simplified, such that it can be produced inexpensively. Furthermore, by means of the sandwich-like structure of the insulation layer and of the connecting elements, the cell connectors and/or the at least one terminal connection, a flexible connecting device of sandwich-like form can be provided. The connecting device may be formed as a mechanically stable assembly composed of foil-like insulation layers and the connecting elements, which are in particular of grid-like form. The insulation layers may realize flexibility, wherein the connecting elements can permit mechanical stability.

It may be advantageous for the insulation layers to be adhesively connected to one another, in particular welded or adhesively bonded, at least in certain portions. It is conceivable for at least one insulation layer to be of self-adhesive form, such that the insulation layer, the connecting elements, the at least one terminal connection and/or the cell connectors can be easily cohesively connected to one another, in particular in sandwich-like form. It is furthermore conceivable for the insulation layers to be thermally joined to one another, in particular welded. The cohesive connection of the insulation layers, and the cohesive sandwich-like structure thus realized, can prevent external influences leading for example to corrosion of the connecting elements, of the cell connectors and/or of the at least one terminal connection. Furthermore, the stability is increased by the cohesive connection of the insulation layers. By means of the thermal joining, in particular lamination and/or welding, of the insulation layers or by means of the adhesive bonding of the insulation layers to one another, positively locking insulation of the connecting elements, of the cell connectors and/or of the terminal connections can be realized. The ingress of moisture or chemical constituents, which could lead to damage to the connecting elements, the cell connectors and/or the at least one terminal connection, can thus be at least reduced.

It is preferable that the connecting elements are in the form of leadframes and/or the connecting elements have a thickness between approximately 50 μm and approximately 5 mm, preferably between approximately 100 μm and approximately 2 mm, particularly preferably between approximately 300 μm and approximately 1 mm. A leadframe can be produced particularly easily and thus inexpensively. The connecting elements, the cell connectors and/or the at least one terminal connection may in this case be formed entirely as a leadframe, such that the connecting elements, the cell connectors and/or the at least one terminal connection are formed cohesively with one another. Such components can thus be formed as a single piece. The connecting elements, in particular the cell connectors and/or the at least one terminal connection, may have a material thickness between approximately 50 μm and approximately 5 mm. The thickness of the connecting device can be varied by means of the material thickness. It is thus possible for the flexibility, mechanical stability and/or the compact construction of the connecting device to be influenced. The thinner the lead frame, the more flexible and compact the construction of the connecting device. A greater material thickness permits increased stability and thus improved protection against mechanical influences. Furthermore, in the case of a greater material thickness, higher currents can be transmitted. It is furthermore conceivable for the connecting elements, the cell connectors and/or the at least one terminal connection to have mutually different material thicknesses.

It is advantageously possible for at least one cell connector or one terminal connection, in particular the connecting elements, to be of multi-layer form. In particular, it is advantageous if the cell connectors, the at least one terminal connection and/or the connecting elements have aluminum, copper and/or nickel. It is thus possible to realize a sandwich-like structure composed of multiple layers, wherein the layers are preferably cohesively connected to one another. It is conceivable for the layers to each have different materials, in particular aluminum, copper and/or nickel. It is furthermore conceivable for at least one additional layer to be provided, wherein the additional layer has aluminum oxide, whereby an electrically insulating layer can be formed. It is for example conceivable for two layers composed of aluminum to be provided, wherein, between the aluminum layers, there is provided at least one copper and/or nickel layer. It is furthermore conceivable for the cell connectors and/or the terminal connection to have, for example, two aluminum layers, wherein a copper layer is formed between the aluminum layers and the copper layer extends from the cell connectors and/or the at least one terminal connection as connecting elements, in particular as a leadframe. The cell connector and/or the at least one terminal connection thus have a sandwich-like structure, wherein the connecting elements are formed merely by a copper layer. Here, aluminum is advantageous for cohesively connecting the cell connectors to the battery cells, for example by laser welding. Here, copper exhibits good electrical and thermal conductivity.

It is advantageous if at least one protective element for improving the electrical and/or electromagnetic compatibility is provided at least in certain portions, wherein the protective element is cohesively connected to at least one insulation layer. The protective elements may in this case serve as a filter and/or as a shield for the electrical and/or electromagnetic radiation. Here, the protective elements may for example be formed as shield plates, and may preferably be surrounded by at least one insulation layer.

It is advantageously possible for at least one reinforcement element to be provided for stiffening purposes, wherein, in particular, the reinforcement element is arranged between at least two insulation layers. Here, the reinforcement element may have plastic, metal and/or fiber-reinforced plastic. It is furthermore conceivable for the reinforcement element to simultaneously be designed as a protective element for improving the electrical and/or electromagnetic compatibility. By means of a reinforcement element according to the invention, the mechanical characteristics of the connecting devices can be improved. It is particularly preferable if the at least one reinforcement element is arranged in the region of the connection contacts. The reinforcement element may advantageously be formed as a grid structure between the at least two insulation layers. It is conceivable for the reinforcement element to have a thickness of approximately 300 μm and approximately 5 mm.

It is particularly preferable if the cell connectors and/or the at least one terminal connection have in each case at least one, preferably five, deformation elements for elastic deformation purposes, wherein, in particular, at least the deformation element is of undulating or polygonal design. Here, a deformation element according to the invention may serve as a tolerance compensation means for the cell connectors and/or the at least one terminal connection, such that, for example, deformations caused by mechanical influences can be compensated. Here, the deformation elements may be formed as apertures in the cell connector, and in particular, the deformation elements may be bent, punched, milled and/or form incisions in the cell connector. It is conceivable for the deformation elements to form apertures of linear, undulating or polygonal form in the cell connectors. It is furthermore conceivable for the deformation elements to have elastic material, wherein the elastic material permits an elastic deformation of the cell connectors. According to the invention, the deformation elements may be of two-dimensional and/or three-dimensional form. For example, the deformation elements may be formed as undulating apertures and/or cell connectors of undulating form.

Preferably, on at least one connecting element, there may be arranged at least one electrical resistance for measuring a voltage drop. By means of the electrical resistance and the voltage drop thus realized, the electrical current supplied by the battery cells can be determined.

It may be advantageous if at least one fixing means is provided, in particular on the reinforcement element, whereby positioning on an external component, in particular an electrical storage unit and/or a battery module, can be achieved. A fixing means may in this case be formed as a recess, for example a bore, in particular in the reinforcement element and/or in the insulation layers. A fastening element may for example be arranged in the fixing means, such that an in particular non-positively locking connection between the connecting device and an external component, in particular an electrical storage unit and/or a battery module, can be realized. The fixing means may furthermore be formed as a clip connection, detent connection and/or adhesive connection. The fixing means according to the invention may likewise serve for positioning an electronics unit on the connecting device.

It is advantageously possible for at least one electrically conductive contact element to be arranged on the cell connector and/or on the terminal connection. The electrically conductive contact element may for example be a voltage tap. The electrically conductive contact element may in this case be designed for example as a plug element, such that an electrically conductive connection to the contact element is made possible from the outside, for example by plugging on. The electrically conductive contact element may in this case be formed in one piece, in particular cohesively, with the cell connector and/or the terminal connection.

According to a second aspect of the invention, a battery module having a multiplicity of electrical storage units, in particular for a vehicle, is provided, wherein the electrical storage units are connected to one another in electrically conductive fashion by means of a connecting device according to the invention. Thus, for the battery module, all of the advantages that have already been discussed with regard to the connecting device according to the invention are realized.

According to a third aspect of the invention, a method for producing a connecting device according to the invention is provided. Here, the method has at least the following steps:
positioning connecting elements on a first insulation layer,
arranging a second insulation layer on the first insulation layer and the connecting elements arranged thereon at least in certain portions, whereby the connecting elements are electrically insulated to the outside and form an intermediate layer,
cohesively connecting the first insulation layer to the second insulation layer, resulting in a sandwich-like structure.

Accordingly, for the method according to the invention, all of the advantages that have already been discussed with regard to the connecting device according to the invention are realized. The cohesive connection of the first insulation layer to the second insulation layer may be made possible here by thermal joining and/or adhesive bonding of the two insulation layers.

Further measures which improve the invention will emerge from the following description of a number of exemplary embodiments of the invention, which are schematically illustrated in the figures. All of the features and/or advantages that emerge from the claims, the description or the drawings, including structural details, spatial arrangement and method steps, may be essential to the invention both individually and in a wide variety of combinations. It is to be noted here that the figures are merely of a descriptive nature and are not intended to restrict the invention in any form.

### BRIEF DESCRIPTION OF THE DRAWINGS

In the figures that follow, identical reference designations will be used for the same technical features even in different exemplary embodiments. In the figures:

FIG. 1 shows a first embodiment of a connecting device according to the invention,

FIG. 2 shows a further embodiment of the connecting device according to the invention,

FIG. 3 shows a possible embodiment of a battery module according to the invention,

FIG. 4 shows a detail of a possible embodiment of a connecting device according to the invention.

### DETAILED DESCRIPTION

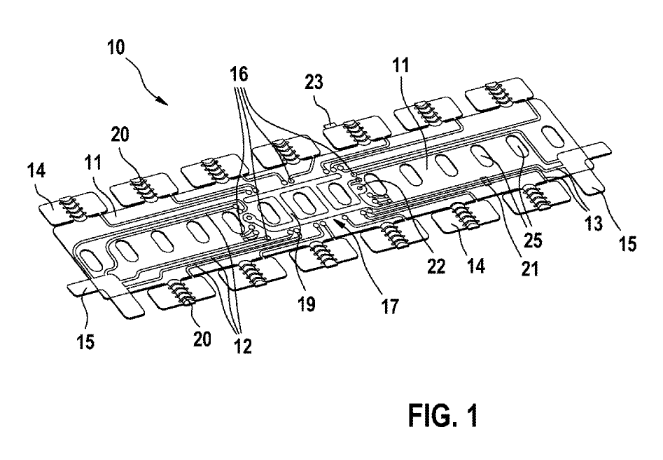

FIG. 1 shows a first embodiment of a connecting device 10 according to the invention for electrically connecting electrical storage units, in particular of a vehicle. The connecting device 10 has at least two insulation layers 11, wherein, between the insulation layers 11, there are arranged connecting elements 12, cell connectors 14 at least in certain portions, and terminal connections 15 at least in certain portions. The cell connectors 14 are arranged, and cohesively connected to the connecting elements 12, on the longitudinal sides of the connecting device 10. The one upper insulation layer 11 covers the cell connectors 14 at least in a central region, wherein deformation elements 20 are arranged in this region of the cell connectors 14. Furthermore, terminal connections 15 are arranged at the at least one longitudinal side and at the two width sides of the connecting device 10. The terminal connections 15 are also surrounded, in particular in positively locking fashion, at least in certain portions by the insulation layers 11. On at least one cell connector 14, there is arranged a contact element 23, in particular for a voltage tap. The cell connectors 14 are in this case arranged parallel to one another at the longitudinal sides of the connecting device 10. Centrally or in the middle of the connecting device 10, there is situated a connection region 17, wherein connection contacts 16 are arranged in the connection region 17. The connection contacts 16 form the second end of the connecting elements 12, wherein a connection to an electronics unit can be produced by means of the connection contacts 16. By means of the electronics unit, information items of the electrical storage units, in particular battery cells, can be transmitted via the connecting elements 12 and the cell connectors 14 and terminal connections 15 arranged cohesively with the connecting elements 12. In the connection region 17, there is furthermore arranged a reinforcement element 19, wherein the reinforcement element 19, in the manner of a web, stiffens the connection region 17. The connection contacts 16 are arranged circumferentially on the reinforcement element 19. Furthermore, on the reinforcement element 19, there are arranged two fixing means 22 in the form of material apertures 22. Further material apertures 25 are situated along a central axis of the connecting device 10, wherein the material aperture 25 may serve for example for degassing of the electrical storage units. Furthermore, easier access to the electrical storage units can be made possible by the material aperture 25. The connecting device 10 furthermore has, in FIG. 1, an electrical resistance 21 in the region of the connecting elements 12. The electrical resistance 21 serves for the measurement of a voltage drop, such that the electrical current of the electrical storage units can be determined. The connecting elements 12 have, at a first end, cell connectors 14 and/or terminal connections 15 and, at a second end, connection contacts 16. Accordingly, there is a cohesive and thus electrically conductive connection between the cell connectors 14 or the terminal connection 15 and the connection contacts 16. In FIG. 1, the cell connectors 14 have deformation elements 20, which are formed as undulating material recesses 20 in the center of the cell connectors.

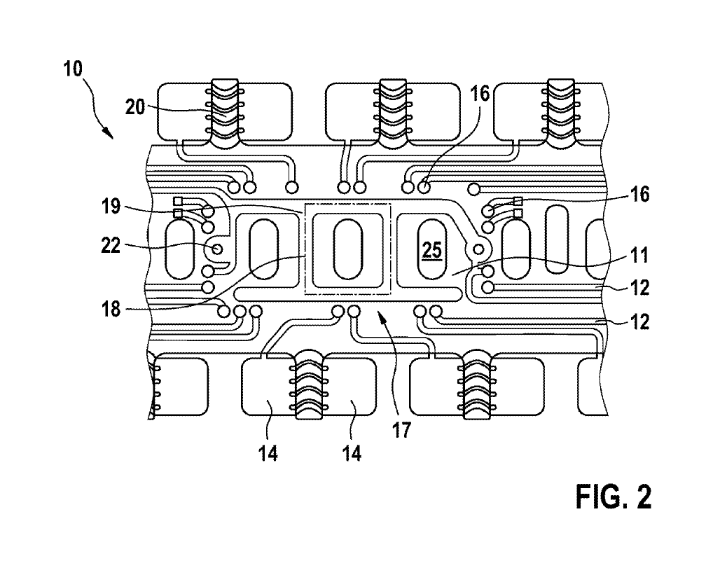

FIG. 2 shows a further possible embodiment of the connecting device 10 according to the invention. In FIG. 2, too, the connecting device 10 has an insulation layer 11, which electrically insulates the connecting elements 12 completely, and the cell connectors 14 in certain portions, to the outside. The foil-like insulation layer 11 is in this case cohesively connected to the connecting elements 12 and in certain portions to the cell connectors 14. At a first end of the connecting elements 12, these are formed cohesively with the cell connectors 14, in particular as a punched part. At a second end of the connecting elements 12, there are arranged connection contacts 16, wherein the connection contacts 16 are free from the insulation layer 11. It is accordingly possible for the connection contacts 16 to be electrically connected to an electronics unit. The electronics unit may for example be a BMS and/or CSC system. In FIG. 2, the cell connectors 14 are also equipped with a deformation element 20, which is of undulating form. Furthermore, the insulation layer 11 has material apertures 25 which permit firstly degassing of the electrical storage units and easier access to the electrical storage units. In the connection region 17 of the connection contacts 16, there is arranged a reinforcement element 19, wherein the reinforcement element 19 has two fixing means 22, such that the connecting device 10 can be positioned on an external component using the fixing means 22.

FIG. 3 shows a detail of a possible embodiment of a battery module 100 according to the invention. The battery module 100 has, in FIG. 3, two electrical storage units 110, wherein the electrical storage units 110 are in the form of battery cells 110. The battery cells 110 each have a connection pole 111, on which the connecting device 10 is positioned by means of the cell connectors 14. The illustrated detail of the connecting device 10 is in this case of sandwich-like form and has two insulation layers 11. The cell connector 14 is arranged between the insulation layers 11, wherein the cell connector 14 is likewise composed of two layers 14, and the connecting element 12 is arranged between the two layers 14 of the cell connector 14. It is advantageous that the two layers 14 of the cell connector 14 have aluminum and the connecting element 12 has copper. Aluminum is easy and thus inexpensive to weld to the connection poles 111 of the electrical storage units 110. The connecting element 12 extends out of the two layers 14 of the cell connectors 14 and can thus be connected at a second end, which is not illustrated in any more detail in FIG. 3, to the connection contacts 16.

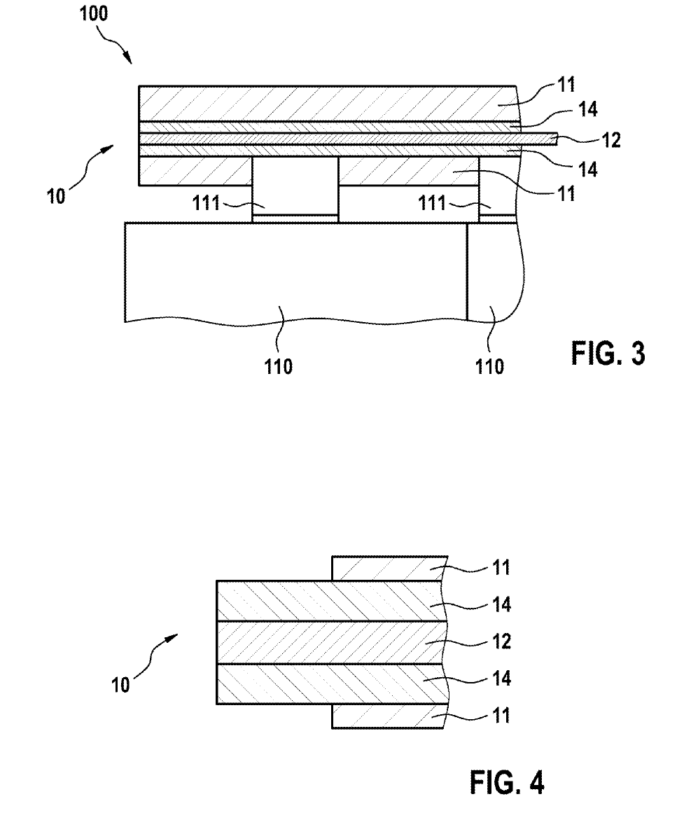

FIG. 4 shows a possible embodiment of a connecting device 10 of sandwich-like construction. The detail of the connecting device 10 in FIG. 4 shows a multi-layer construction, wherein two insulation layers 11 cover, at least in certain portions, the two layers of the cell connectors 14. In particular, the insulation layers 11 are arranged in a region which does not serve for the connection of the cell connectors 14 to a connection pole of an electrical storage unit. The connecting element 12 is, in FIG. 4, arranged between the two layers 14 of the cell connector 14. The connecting element 12 preferably has copper, and the layers 14 of the cell connector 14 preferably have aluminum. The connecting element 12 may in this case have a thickness of approximately 50 μm and approximately 5 mm. The insulation layer 11 is preferably of foil-like, in particular flexible, form, and has at least plastic or aluminum oxide.

The above explanations of the embodiments describe the present invention exclusively in the context of examples. It is self-evidently possible for individual features of the embodiments to be freely combined with one another, where technically expedient, without departing from the scope of the present invention.

1. A connecting device (10) for electrically connecting electrical storage units (110), the connecting device comprising at least two insulation layers (11) and connecting elements (12) arranged between the insulation layers (11), wherein the connecting elements (12) are electrically insulated to an outside by the insulation layers (11), and the connecting elements (12) each have, at a first end, at least one cell connector (14), which is configured for the connection of the electrical storage units (110), and/or a terminal connection (15), wherein the cell connector and/or the terminal connection is formed cohesively with the connecting elements (12).

2. The connecting device (10) as claimed in claim 1, characterized in that the connecting elements (12) each have, at a second end, a connection contact (16) configured to produce an electrically conductive connection to an electronics unit (24).

3. The connecting device (10) as claimed in claim 1, characterized in that the cell connectors (14) and/or the terminal connection (15) is arranged at an edge side on the insulation layer (11) and is surrounded at least in certain portions by at least one insulation layer (11).

4. The connecting device (10) as claimed in claim 1, characterized in that at least one insulation layer (11) is of foil-like form and has at least plastic or aluminum oxide.

5. The connecting device (10) as claimed in claim 1, characterized in that the insulation layers are cohesively connected to one another at least in certain portions.

6. The connecting device (10) as claimed in claim 1, characterized in that the connecting elements (12) are in the form of leadframes, and/or the connecting elements (12) have a thickness between approximately 50 μm and approximately 5 mm.

7. The connecting device (10) as claimed in claim 1, characterized in that at least one cell connector (14) or one terminal connection (15) is of multi-layer form.

8. The connecting device (10) as claimed in claim 1, characterized in that at least one protective element (18) for improving the electrical and/or electromagnetic compatibility is provided at least in certain portions, wherein the protective element (18) is cohesively connected to at least one insulation layer (11).

9. The connecting device (10) as claimed in claim 1, characterized in that at least one reinforcement element (19) is provided for stiffening purposes.

10. The connecting device (10) as claimed in claim 1, characterized in that the cell connectors (14) each have at least one deformation element (20) for elastic deformation purposes.

11. The connecting device (10) as claimed claim 1, characterized in that, on at least one connecting element (12), there is arranged at least one electrical resistance (21) for measuring a voltage drop.

12. The connecting device (10) as claimed in claim 1, characterized in that further comprising at least one fixing means (22) for positioning on an external component.

13. The connecting device (10) as claimed in claim 1, characterized in that at least one electrically conductive contact element (23) is arranged on the cell connector (14) and/or on the terminal connection (15).

14. A battery module (100) having a multiplicity of electrical storage units (110), wherein the electrical storage units (110) are connected to one another in electrically conductive fashion by means of a connecting device (10) according to claim 1.

15. A method for producing a connecting device having the features of claim 1, the method comprising the steps:
a) positioning connecting elements on a first insulation layer,
b) arranging a second insulation layer on the first insulation layer and the connecting elements, whereby the connecting elements are electrically insulated to an outside and form an intermediate layer, and
c) cohesively connecting the first insulation layer to the second insulation layer, resulting in a sandwich-like structure.

16. The connecting device (10) as claimed in claim 1, characterized in that at least one insulation layer (11) is of flexible form and has at least plastic or aluminum oxide.

17. The connecting device (10) as claimed in claim 1, characterized in that the insulation layers are welded or adhesively bonded to one another, at least in certain portions.

18. The connecting device (10) as claimed in claim 1, characterized in that the connecting elements (12) are in the form of leadframes, and/or the connecting elements (12) have a thickness between approximately 100 μm and approximately 2 mm.

19. The connecting device (10) as claimed in claim 1, characterized in that the connecting elements (12) are in the form of leadframes, and/or the connecting elements (12) have a thickness between approximately 300 μm and approximately 1 mm.

20. The connecting device (10) as claimed in claim 1, characterized in that the connecting elements (12) are is of multi-layer form.

21. The connecting device (10) as claimed in claim 1, characterized in that the connecting elements (12) are is of multi-layer form, having at least aluminum, copper or nickel.

22. The connecting device (10) as claimed in claim 1, characterized in that at least one reinforcement element (19) is provided for stiffening purposes, wherein the reinforcement element (19) is arranged between the insulation layers (11).

23. The connecting device (10) as claimed in claim 1, characterized in that the cell connectors (14) each have five deformation elements (20) for elastic deformation purposes, wherein at least one deformation element (20) is of undulating or polygonal design.

24. The connecting device (10) as claimed in claim 1 further comprising at least one fixing means (22), on the reinforcement element (19), for positioning on an electrical storage unit (110) or a battery module (100).
